(19) United States
(12) Patent Application Publication
(10) Pub. No.: US 2006/0209679 A1
(43) Pub. Date: Sep. 21, 2006

(54) Transceiver, optical transmitter, port-based switching method, program, and storage medium

(75) Inventor: Naoto Ishino, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/377,021

(22) Filed: Mar. 16, 2006

(30) Foreign Application Priority Data
Mar. 18, 2005 (JP) 079243/2005

(51) Int. Cl. H04J 1/16

(52) U.S. Cl. 370/216; 370/366

(57) ABSTRACT

In a transceiver having a plurality of ports, switching is determined on a port basis. A transceiver that is redundantly configured, has a plurality of interface ports, and implements serial communications of switching-control information for each interface port is characterized by including a switching-control circuit for creating the switching-control information items and implementing control so that the interface ports are switched, a parallel-to-serial conversion circuit for serial-converting the switching-control information items, and a serial-to-parallel conversion circuit for parallel-converting the switching-control information items that have been serial-converted.

### BACKGROUND OF THE INVENTION

The present invention relates to a transceiver, in an optical transmission system having a redundant configuration, that has a plurality of interface ports for respective client apparatuses, and to switching control in the transceiver.

### DESCRIPTION OF RELATED ART

FIG. 1 illustrates conventional transceivers in an optical transmission system having a redundant configuration. As can be seen from FIG. 1, each of transceivers A(4-1) and B(4-2) has a single interface port. That is to say, they are single-port-to-transceiver devices (a transceiver with one port). Through an optical-to-electrical conversion (OE)/an electrical-to-optical conversion (EO), a signal from a transmission line is optically outputted through a coupler 4-5 to a client apparatus 4-11. When the transceiver A(4-1) is required to optically output signals, a switching control circuit 4-3 outputs a control signal to an EO/OE section 4-9 so that the EO/OE section 4-9 optically outputs signals. In the transceiver B(4-2), a switching-control-section circuit 4-4 outputs a control signal to an EO/OE section 4-10 so that the EO/OE section 4-10 stops optical outputting. In this situation, the transceiver A(4-1) and the transceiver B(4-2) function as an active system and a standby system, respectively.

A general method of communicating switching-control information for a single-port-to-transceiver device will be explained, with reference to FIG. 2. The transceiver A(5-1) and the transceiver B(5-2) are an active system and a standby system, respectively. Between the backboards of the housings, respective switching-control information items (generic names for PKG failure information items A(5-5) and B(5-9), signal fault information items A(5-6) and B(5-10), signal deterioration information items A(5-7) and B(5-11), and main-signal selection information items A(5-8) and B(5-12)) are transmitted and received. When a signal fault occurs in the transceiver A(5-1), the transceiver A(5-1) notifies the transceiver B(5-2) of the signal fault information A(5-6) created by a switching-control-section circuit 5-3. In response to the information, the transceiver A(5-1) is switched to a standby system and the transceiver B(5-2) to an active system.

In addition, the switching-control-section circuits 5-3 and 5-4 compare and determine the importance levels of the respective faults in the transceivers, and a transceiver with less serious failures is selected as an active system. If the faults listed in the descending order of importance are the PKG failure information items A(5-5) and B(5-9), the signal fault information items A(5-6) and B(5-10), the signal deterioration information items A(5-7) and B(5-11), even when the transceiver A(5-1) creates the signal deterioration information A(5-7), the switching is not implemented as long as the transceiver B(5-2) creates the signal fault information B(5-10). As described above, in the backboards of the housings, a plurality of conducting wires should be provided, in order to communicate the signal fault information items A(5-6) and B(5-10), the main-signal selection information items A(5-8) and B(5-12), and the like.

Next, FIG. 3 illustrates transceivers each having a plurality of interface ports for respective client apparatuses. That is to say, they are multiple-port-to-transceiver devices. After passing through an EO/OE section 6-7, a signal from a transmission line is separated by a multiplex/division section 6-11 into signals for the respective client apparatuses. After passing through an EO/OE section 6-9 and respective couplers 6-5, the separated signals are optically outputted to the respective client apparatuses 6-13. Each EO/OE section 6-9 has a corresponding switching-control-section circuit 6-3. When a signal corresponding to a specific port of the transceiver A(6-1) is optically outputted, a switching control circuit 6-3 corresponding to the specific port outputs a control signal to the corresponding EO/OE section 6-9 so that the EO/OE section 6-9 optically outputs the signal. In this situation, a switching-control-section circuit 6-4 for the corresponding port of the transceiver B(6-2) outputs a control signal to an EO/OE section 6-10 so that the EO/OE section 6-10 stops optical outputting.

However, if the transceivers with multiple ports are switched using a housing for a transceiver with one port, only switching on a transceiver basis is possible with the method illustrated in FIG. 2 since there are not enough conducting wires on the backboard. In the case where a single transceiver has a plurality of interface ports for client apparatuses, even a fault at a single port causes all ports to be switched. In the case where port-based switching is requested, the housing should be changed, due to shortage of conducting wires on the backboard of the housing.

Japanese Patent Application Laid Open No. 2002-164863 titled “Channel Switching System” discloses a technique in which, in order to prevent unnecessary switching that, regardless of the configuration of a redundant system, is caused through maintenance or difference in delay in transmission lines, switching information (that is considered as the foregoing switching-control information) for implementing channel switching is transmitted by means of serial communication to implement switching control for an active system and a standby system. It should be considered that, because the serial communication enables output to a single control line, whereby channels can concurrently be switched, the foregoing difference in delay does not occur.

However, the “Channel Switching System” disclosed in Japanese Patent Application Laid Open No. 2002-164863 relates to channel switching in a configuration in which a plurality of pairs each consisting of a transceiver and a single corresponding channel is provided. In other words, the system is a multiple-port-to-multiple-transceiver device. Even though a plurality of channels exists and a plurality of interface ports exists, only a single port corresponds to a single transceiver. Accordingly, the foregoing problems with a multiple-port-to-transceiver device do not occur. Even if a fault occurs in a channel for other transceivers, the transceiver does not have to switch any channel of its own.

### SUMMARY OF THE INVENTION

In view of the above circumstances, the issue to be solved by the present invention is to provide a method, and the like, in which, in a transceiver with a plurality of ports, necessity of switching is determined on a port basis.

An aspect of the present invention to solve the foregoing problems relates to a transceiver in a redundant configuration comprising a plurality of interface ports wherein serial communications of switching-control information for each interface port are established.

The transceiver is characterized by including a switching-control section for creating the switching-control information and implementing control so that the interface ports are switched, a serial conversion section for serial-converting the switching-control information, and a parallel conversion section for parallel-converting the switching-control information that have been serial-converted.

It is preferable that the serial conversion section creates a frame pulse and a clock pulse and implements parallel transmission of the switching-control information, the frame pulse, and the clock pulse. Moreover, it is preferable that the transceiver implements the parallel transmission through a backboard.

Another aspect of the present invention relates to an optical transmission system equipped with the transceiver.

Still moreover, another aspect of the present invention relates to a port-based switching method characterized in that faults at a plurality of interface ports are compared and determined from a standpoint of importance, and serial communications of switching-control information for each interface port are implemented, based on the comparison and determination.

It is preferable that, in the serial communications, parallel transmission of the switching-control information, a frame pulse, and a clock pulse is implemented. Moreover, it is preferable that the transceiver implements the parallel transmission through a backboard.

Still moreover, another aspect of the present invention relates to a computer program product embodied on a computer-readable medium that causes a computer to perform processing of comparing and determining from a standpoint of importance faults at a plurality of interface ports and processing of carrying out serial communication of switching-control information for each interface port, based on the comparison and determination.

It is preferable that, in the serial communication, parallel transmission of the switching-control information, a frame pulse, and a clock pulse is performed. Moreover, it is preferable that the parallel transmission through a backboard is performed.

In addition, another aspect of the present invention relates to a storage medium in which the program is stored.

In a transceiver that is redundantly configured, even if a plurality of interface ports exists, an active system and a standby system can be set on an interface port basis, by serializing switching-control information for each port.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram illustrating the configuration of a conventional transceiver;

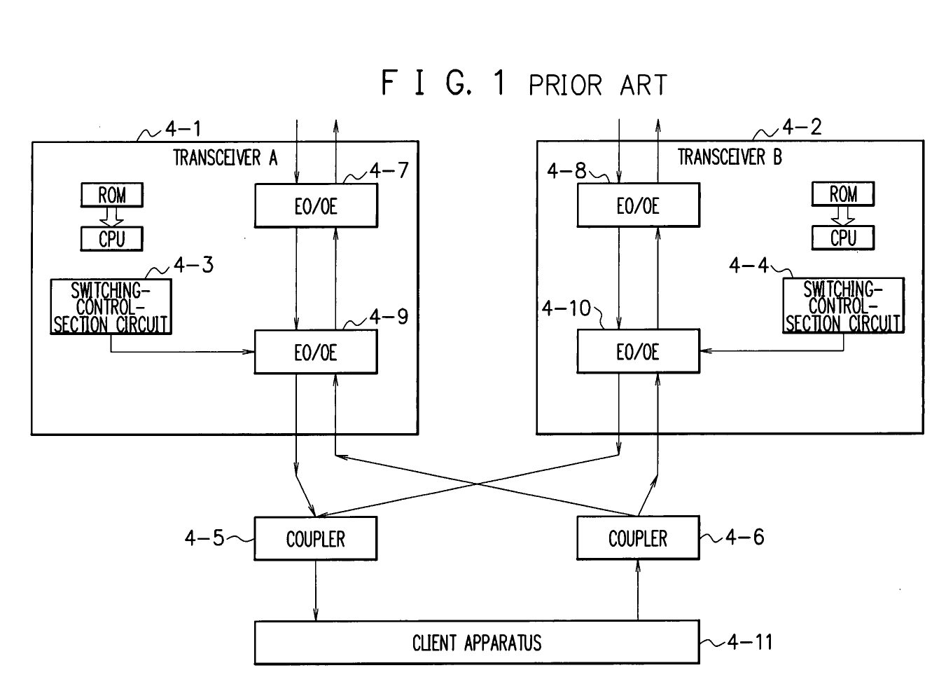

FIG. 2 is a diagram illustrating switching-control information items 5-5 to 5-12 communicated between transceivers each having a single port;

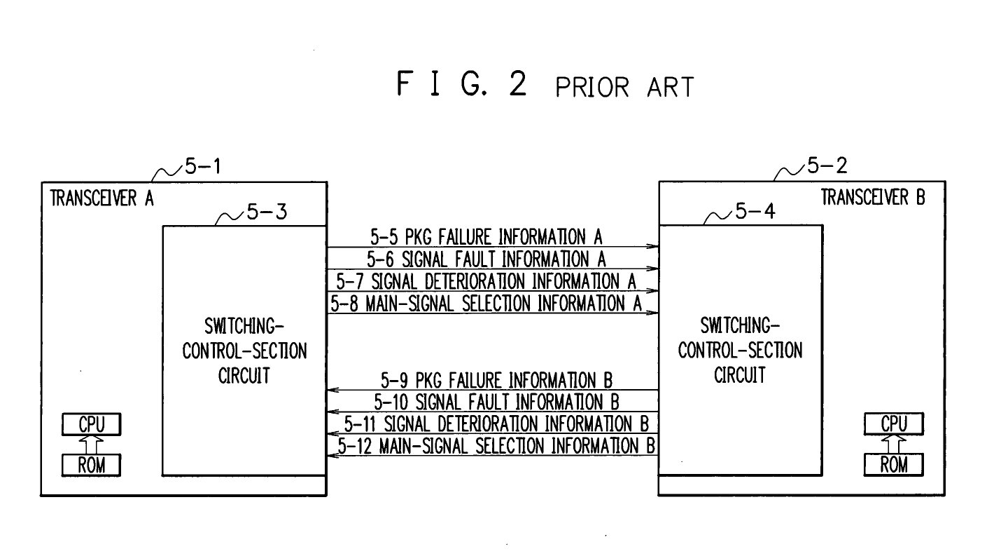

FIG. 3 is a block diagram illustrating the configurations of transceivers each having a plurality of interface ports for client apparatuses.

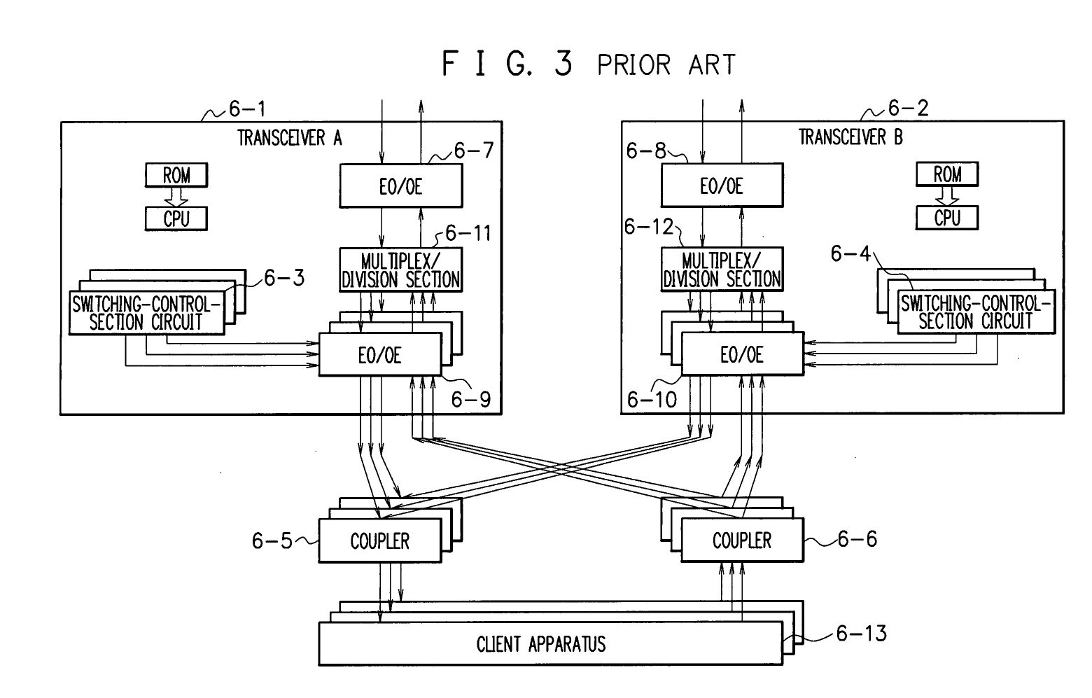

FIG. 4 is a block diagram illustrating the configuration of a transceiver according to the present invention;

FIG. 5 is a set of timing charts representing a clock pulse A(2-1), a frame pulse A(2-2), and serial data A(2-3) for transmitting switching-control information; and

FIG. 6 is a table representing bit assignment in serial data A(2-3).

### DESCRIPTION OF THE PREFERRED EMBODIMENTS

An embodiment for implementing a transceiver and the like according to the present invention will be explained below. In making the explanation, drawings submitted herewith will appropriately be referred to.

[Configuration]

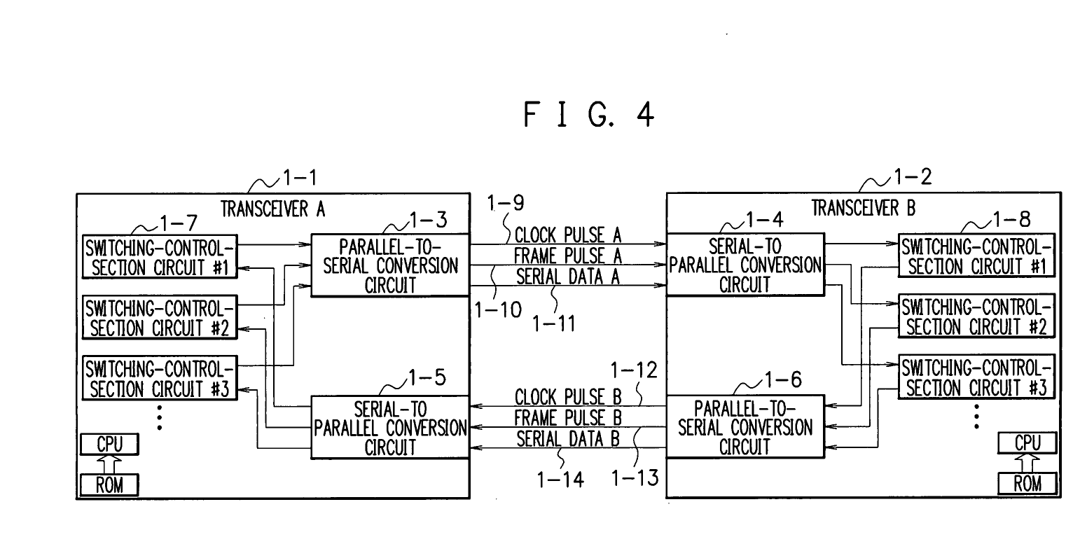

A transceiver according to the present invention will be explained with reference to FIG. 4. Each of transceivers A(1-1) and B(1-2) has a plurality of interface ports. That is to say, they are multiple-port-to-transceiver devices. The transceiver A(1-1) and the transceiver B(1-2) are an active system and a standby system, respectively. The transceiver A(1-1) and the transceiver B(1-2) establish bothway communications through a backboard of the same housing, serial data A(1-11) and B(1-14) that are serialized switching-control information items, clock pulses A(1-9) and B(1-12) for synchronization, and frame pulses A(1-10) and B(1-13) that indicate start points of frames, through parallel transmission. The transceivers A(1-1) and B(1-2) have respective parallel-to-serial conversion circuits 1-3 and 1-6 that serial-convert predetermined information items and create clock pulses A(1-9) and B(1-12) and frame pulses A(1-10) and B(1-13), respectively, and respective serial-to-parallel conversion circuits 1-5 and 1-4 that parallel-convert the serialized information items. Respective switching-control information items created by switching-control-section circuits 1-7 corresponding to ports of the transceiver A(1-1) are inputted to the parallel-to-serial conversion circuit 1-3. In the parallel-to-serial conversion circuit 1-3, the switching-control information items from all the ports are serialized, parallel-transmitted through the backboard, along with the clock pulse A(1-9) and the frame pulse A(i-10), and inputted to the serial-to-parallel conversion circuit 1-4 of the transceiver B(1-2). In the serial-to-parallel conversion circuit 1-4, the serial data A(1-11) is parallel-converted, based on the clock pulse A(1-9) and the frame pulse A(1-10). Then, respective switching-control-section circuits 1-8 corresponding to ports of the transceiver B(1-2) receive the switching-control information items for the transceiver A(1-1).

In addition, each of the transceivers A(1-1) and B(1-2) is equipped with a CPU (Central Processing Unit) that integrally controls the circuits, i.e., implements central processing control and a ROM (Read Only Memory) that stores a program that the CPU reads to implement the central processing control.

[Operation]

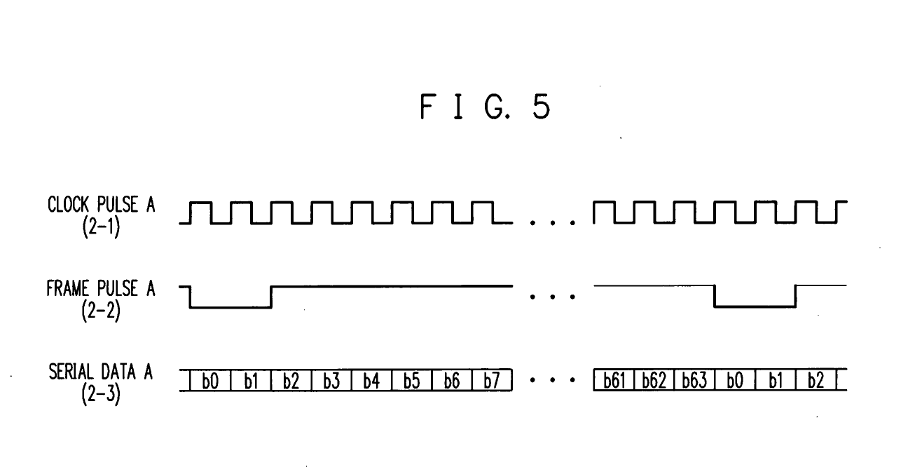

FIG. 5 represents an example of the timing chart. In the present embodiment, as an example, it is assumed that the number of the interface ports is four, and the switching-control information consists of the signal fault information, the signal deterioration information, and the main-signal selection information. The speed of the clock pulse A(2-1) is in a range such that the time limit of switching control can be satisfied therewith. Conventional switching-control information is defined as serial data A(2-3) and a frame pulse A(2-2) is provided that indicates the starting position of the serial data A(2-3). In the serial data A(2-3), one frame consists of 64 bits.

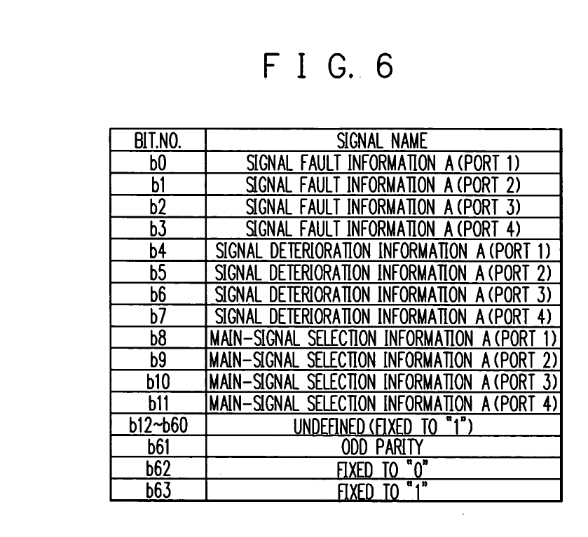

In the transceiver A(1-1), the respective switching-control information items created in the switching-control-section circuits are assigned in the parallel-to-serial conversion circuit 1-3 to the respective bits in the serial data A(2-3). FIG. 6 represents bit assignment in serial data A(2-3). Signal fault information A for Port 1 is assigned to bit b0; signal fault information A for Port 2 to bit b1; signal fault information A for Port 3 to bit b2; and signal fault information A for Port 4 to bit b3. Signal deterioration information A and main-signal selection information A are also assigned to respective bits (b4 to b7 and b8 to b11, respectively). Bits b12 to b60 are left undefined and fixed to “1”. When being increased, the switching-control information items and the ports are assigned to the bits b12 through b60. Moreover, a bit b61 is defined as an odd parity; the sum of b0 through b61 is “1”. Still moreover, bits b62 and b63 are defined as fixed values (b62 is “0” and b63 is “1”) and utilized for determining the status of the serial communication. The serial data A(2-3) having the bits assigned as described above is transmitted through the backboard of the housing to the transceiver B(1-2). In the serial-to-parallel conversion circuit 1-4, the serial data A(2-3) is parallelized and inputted to the respective switching-control-section circuits 1-8. In the switching-control-section circuits 1-8, respective faults of the ports are compared and determined from a standpoint of importance; if a port having a heavy fault exists, that port is switched to a port having a lighter fault.

Through the processing operation as described above, the respective switching-control information items for the ports of the active system transceiver and the standby system transceiver are exchanged in serial communications by way of the backboards; therefore, even if the interface port is multiple-port, switching can be implemented on a port basis. Moreover, even if the number of ports is increased, the existing housing can be utilized as it is.

In general, serial data including a clock pulse and a frame pulse is transmitted, and in the receiver, the clock pulse and the frame pulse are extracted and read; however, in the present embodiment, serial data, a clock pulse, and a frame pulse are transmitted in parallel. Accordingly, in the transceiver, no circuit is required that extracts the clock pulse and the frame pulse, whereby the circuit can be downsized.

In addition, although being optimal for implementing the present invention, the foregoing embodiment does not intend to limit the scope of the present invention thereto. Therefore, various modifications are possible as long as the gist of the present invention is not changed.

For example, the switching-control-section circuits 1-7 and 1-8 are not required to be provided for the respective ports and may be a single circuit that integrally creates the switching-control information for each port.

Development of an optical transmission system and the like that are equipped with a transceiver according to the present embodiment is desired.

What is claimed is:

1. A transceiver in a redundant configuration comprising a plurality of interface ports wherein serial communications of switching-control information for each interface port are established.

2. The transceiver according to claim 1, further comprising:
a switching-control section for creating the switching-control information and implementing control so that the interface ports are switched;
a serial conversion section for serial-converting the switching-control information; and
a parallel conversion section for parallel-converting the switching-control information that have been serial-converted.

3. The transceiver according to claim 2, wherein the serial conversion section creates a frame pulse and a clock pulse and implements parallel transmission of the switching-control information, the frame pulse, and the clock pulse.

4. The transceiver according to claim 3, wherein the transceiver implements the parallel transmission through a backboard.

5. An optical transmission system equipped with the transceiver according to any one of claims 1 to 4.

6. A port-based switching method in which faults at a plurality of interface ports are compared and determined from a standpoint of importance, and serial communications of switching-control information for each interface port are implemented, based on the comparison and determination.

7. The port-based switching method according to claim 6, wherein, in the serial communications, parallel transmission of the switching-control information, a frame pulse, and a clock pulse is implemented.

8. The port-based switching method according to claim 7, wherein the parallel transmission is implemented through a backboard.

9. A computer program product embodied on a computer-readable medium and comprising code that, when executed, causes a computer to perform the following:
comparing and determining from a standpoint of importance faults at a plurality of interface ports and
carrying out serial communication of switching-control information for each interface port, based on the comparison and determination.

10. The program according to claim 9 wherein in the serial communication, parallel transmission of the switching-control information, a frame pulse, and a clock pulse is performed.

11. The program according to claim 10 wherein the parallel transmission through a backboard is performed.

12. A storage medium in which the program according to any one of claims 9 to 11 is stored.
